(19) United States
(12) Patent Application Publication
(10) Pub. No.: US 2010/0310105 A1
(43) Pub. Date: Dec. 9, 2010

(54) SPEAKER CASE AND RELATED PROMOTIONAL METHOD

(75) Inventor: EDGAR DAVIS, Surrey (CA)

Correspondence Address: JEFFER, MANGELS, BUTLER & MITCHELL, LLP, 1900 AVENUE OF THE STARS, 7TH FLOOR, LOS ANGELES, CA, 90067, US

(73) Assignee: ANIMAL MARKETING INC., Surrey (CA)

(21) Appl. No.: 12/477,867

(22) Filed: Jun. 3, 2009

(51) Int. Cl. H04R 1/02; B65D 65/00

(52) U.S. Cl. 381/334; 206/427

(57) ABSTRACT

Described herein is a case for holding a plurality of items arranged in an ordered fashion. The case includes a structure having a cavity, the structure having thin walls and being lightweight; a plurality of the items to be disposed in the cavity; and a flat speaker comprising a speaker frame and a speaker, the speaker frame supporting the speaker, the speaker housing being attached to a wall of the structure and extending from outside the wall into the cavity, wherein the speaker is disposed at an area of the wall that does not interfere with the arrangement of items in the cavity.

### FIELD OF THE INVENTION

This invention is directed to speaker case and more particularly to a speaker case for holding a plurality of commercial items, and related methods of promoting the commercial items, contained within the speaker case.

### BACKGROUND OF THE INVENTION

Commercial items are frequently promoted and/or sold in packages. This allows for ease of carrying, transporting, and/or selling those items. Often times, the commercial items contained within those packages are used for consumption, enjoyment, and the like. There is always a need, for example, for improved packages that increase the consumers' desire to buy the commercial items contained therein.

### SUMMARY OF THE PREFERRED EMBODIMENTS

In accordance with one aspect of the present invention there is provided a case for holding a plurality of loose items arranged in an ordered fashion, the case comprising a structure having a cavity, the structure having thin walls and being lightweight; a plurality of items to be disposed in the cavity; and a flat speaker housing comprising a speaker frame and a speaker, the speaker frame supporting the speaker, the speaker housing being attached to a wall of the structure and extending from outside the wall into the cavity, wherein the speaker housing is disposed at an area of the wall that does not interfere with the arrangement of the items in the cavity. In a preferred embodiment, the items to be disposed in the cavity are cans or bottles.

In accordance with another aspect of the present invention there is provided a method for promoting a commercial item that includes the steps of providing a package for housing a plurality of loose identical items in an ordered fashion; attaching a speaker housing to the package; placing a plurality of loose identical items in an ordered fashion in the package; whereby the speaker does not interfere with the placement of items in the package. In a preferred embodiment, the speaker housing is flat and comprises a speaker. Preferably, the loose identical items are bottles or cans. The methods may further comprise the step of providing audio cables that are secured by the speaker housing.

Other features and advantages of the present invention will become apparent to those skilled in the art from the following detailed description. It is to be understood, however, that the detailed description of the various embodiments and specific examples, while indicating preferred and other embodiments of the present invention, are given by way of illustration and not limitation. Many changes and modifications within the scope of the present invention may be made without departing from the spirit thereof, and the invention includes all such modifications.

### BRIEF DESCRIPTION OF THE DRAWINGS

The invention may be more readily understood by referring to the accompanying drawings in which:

FIG. 1 is a front elevational view of a case having speaker housing attached thereto in accordance with a preferred embodiment of the present invention;

FIG. 2 is an exploded view of the speaker housing of FIG. 1 and a cover plate;

FIGS. 3 and 4 are perspective views of a front plate of the speaker housing of FIG. 1;

FIG. 5 is an elevational view of the speaker housing of FIG. 1;

FIGS. 6 and 7 are back elevational views of the speaker housing of FIG. 1;

FIG. 8 is a side elevational view of the speaker housing of FIG. 1;

FIG. 9 is a front elevational view of the case having a speaker and an audio cable connected to a MP3 player;

FIG. 10 is an elevation view of a beer bottle adjacent to a speaker housing;

FIG. 11 is a perspective view of a beer bottle adjacent a speaker housing;

FIG. 12 is a perspective view of a case having a speaker housing and an audio cable attached to a MP3 player; and

FIG. 13 is a top plan view of the case of FIG. 12 having a plurality of cans and a speaker housing attached to the case.

Like numerals refer to like parts throughout the several views of the drawings.

### DETAILED DESCRIPTION

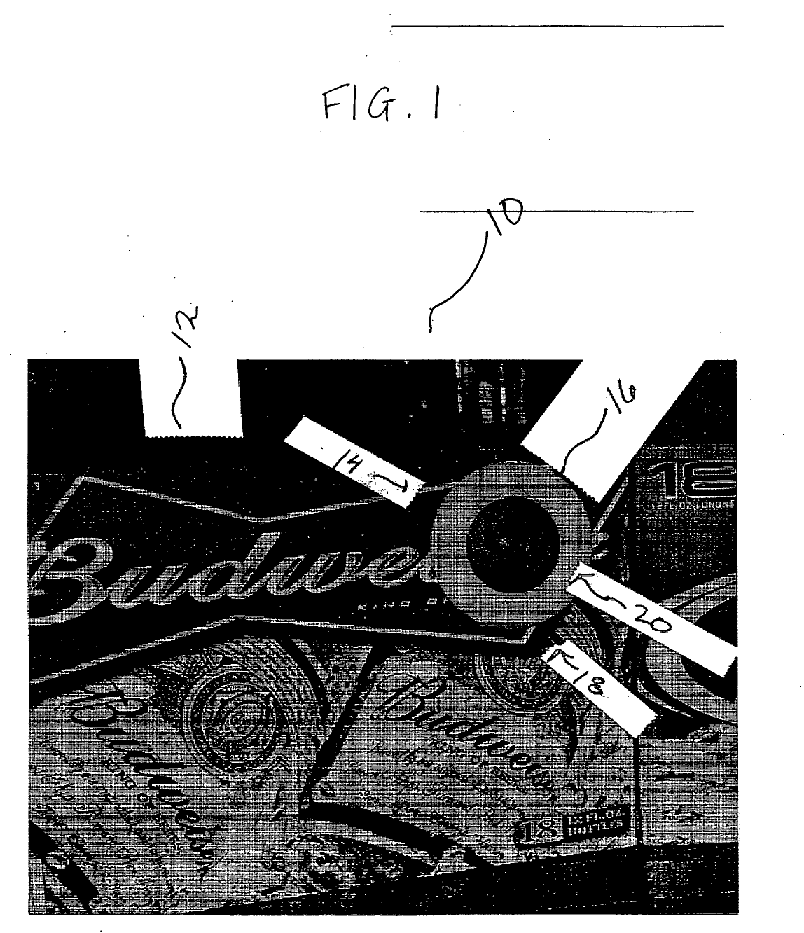

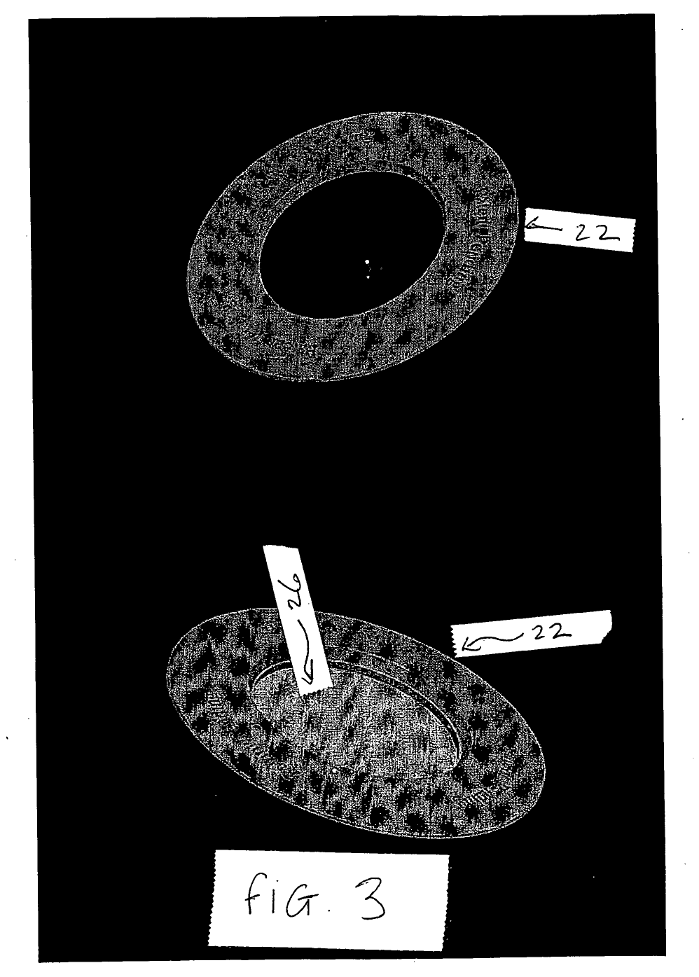

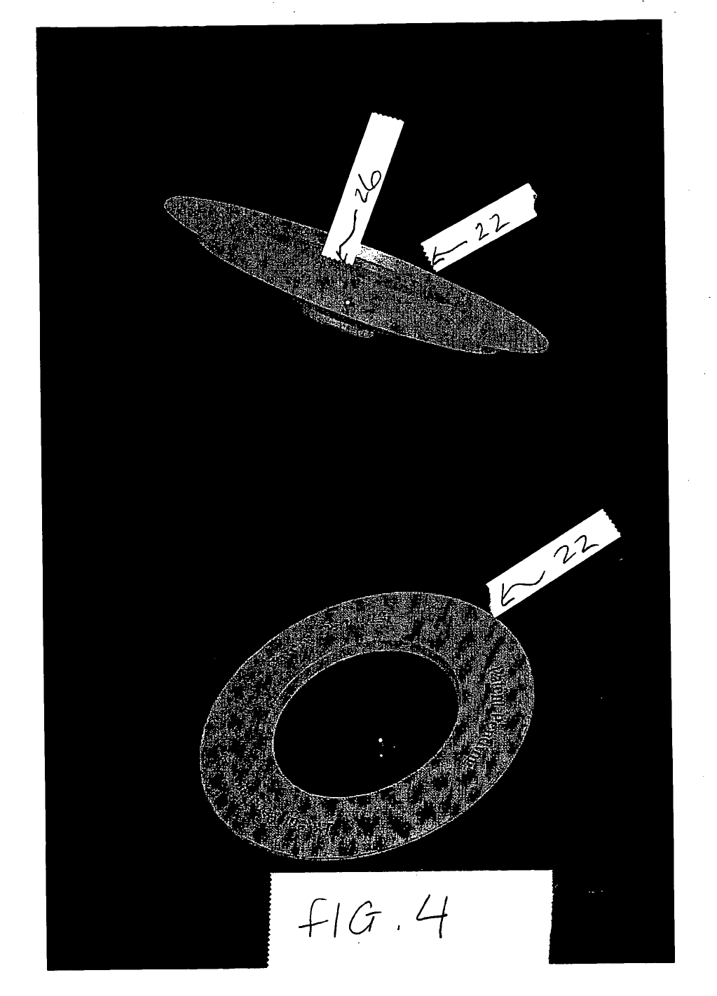

As shown in FIGS. 1-13, the present invention is directed to a case having a speaker housing attached thereto, generally indicated as 10. The case generally includes a plurality of loose items. The speaker housing includes a speaker. As used herein, “case” may be a package, box, or any other container for holding items, or the like.

It will be appreciated that terms such as “front,” “back,” “top,” “bottom,” “left,” “right,” “above,” and “side” used herein are merely for ease of description and refer to the orientation of the components as shown in the figures. It should be understood that any orientation of the components described herein is within the scope of the present invention.

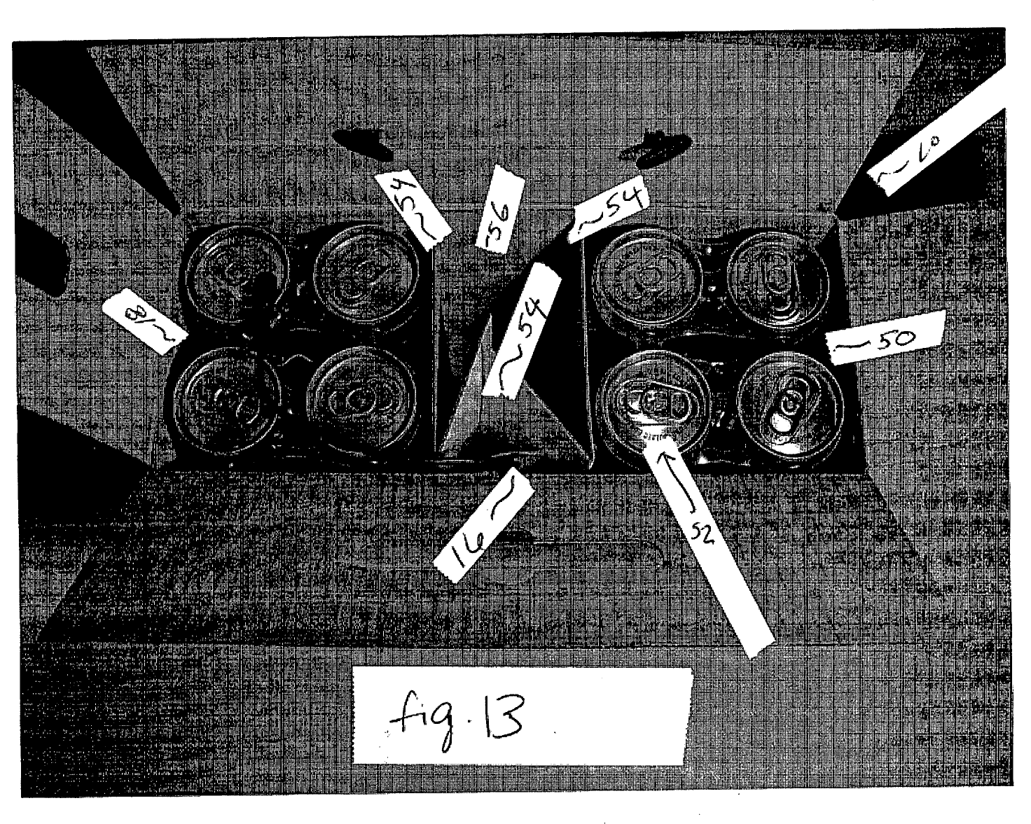

Referring now to FIGS. 1 and 13, the present invention is generally directed to a case 12 having a structure 14. The structure 14 preferably includes a front wall, back wall, top wall, bottom wall, and two side walls defining a cavity 50 (not shown in FIG. 1, but shown in FIG. 13) and a speaker housing 16 attached to one of the walls 18. The speaker housing 16 preferably extends from outside the wall 18 (and outside the structure 14) into the cavity. Preferably, the walls of the structure are thin and are comprised of lightweight durable material such as paper, cardboard or the like. In a preferred embodiment, the speaker housing 16 is flat or substantially flat. In other embodiments, more than one speaker housing 16 may be attached to one or more walls of structure 14.

Preferably, and as best seen in FIG. 13, the cavity 50 houses a plurality of commercial items 52. In a preferred embodiment, the commercial items housed within the cavity are a plurality of loose identical cans or bottles arranged in an ordered fashion. These cans or bottles or other commercial items may be separated from one another by paper and/or cardboard dividers and the like. Preferably, the cans or bottles comprise beer, liquor, soda, or any other beverage of choice. In other embodiments, instead of cans or bottles, other identical or non-identical items may be housed in the case, such as other items used for pleasure, enjoyment, and/or consumption.

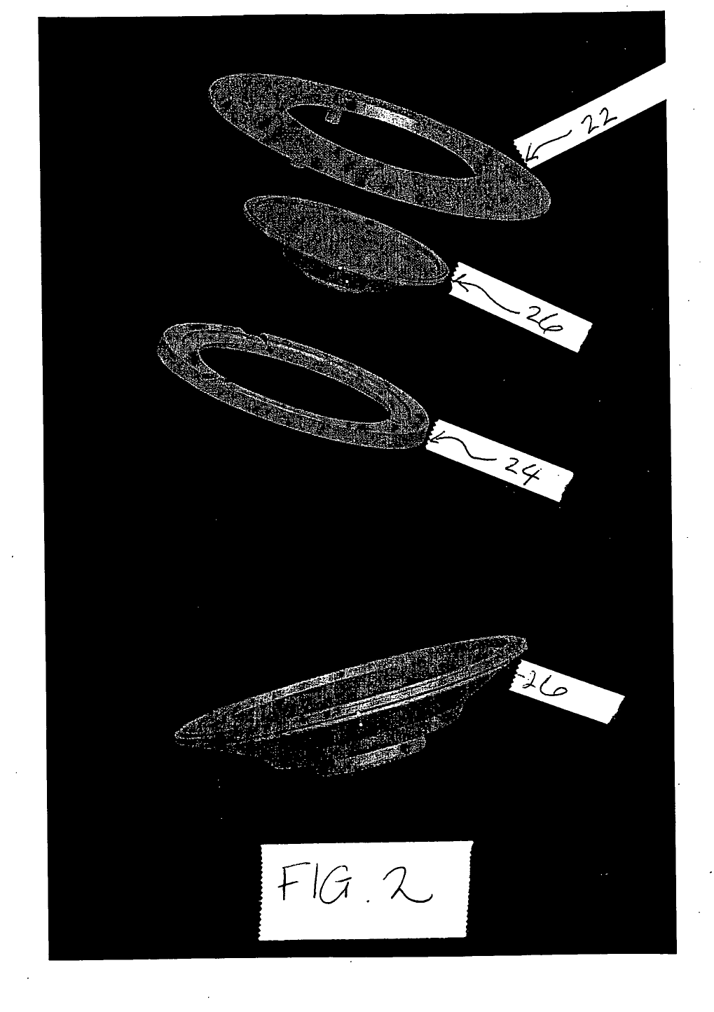

In a preferred embodiment, and referring to FIGS. 2-8, the speaker housing 16 is constructed as follows. Preferably, and as best seen in FIG. 2, the speaker housing 16 includes at least one frame, and preferably includes a front frame 22 and a back frame 24. Both are engaged or otherwise attached to each other. Each of the front frame 22 and the back frame 24 is flat, and the speaker housing 16 itself is flat. Preferably, the front frame 22 is about 95 mm in outer diameter, and is comprised of polypropylene. The back frame 24 is preferably about 73 mm in outer diameter. A speaker 26 is housed in the speaker housing 16. In other embodiments, the diameters of each of the front and back frame may vary without departing from the scope of the present invention. In yet other embodiments, the front and/or the back frame may not be flat and/or may be comprised of other materials. In yet other embodiments, the speaker housing 16 may house more than one speaker 26.

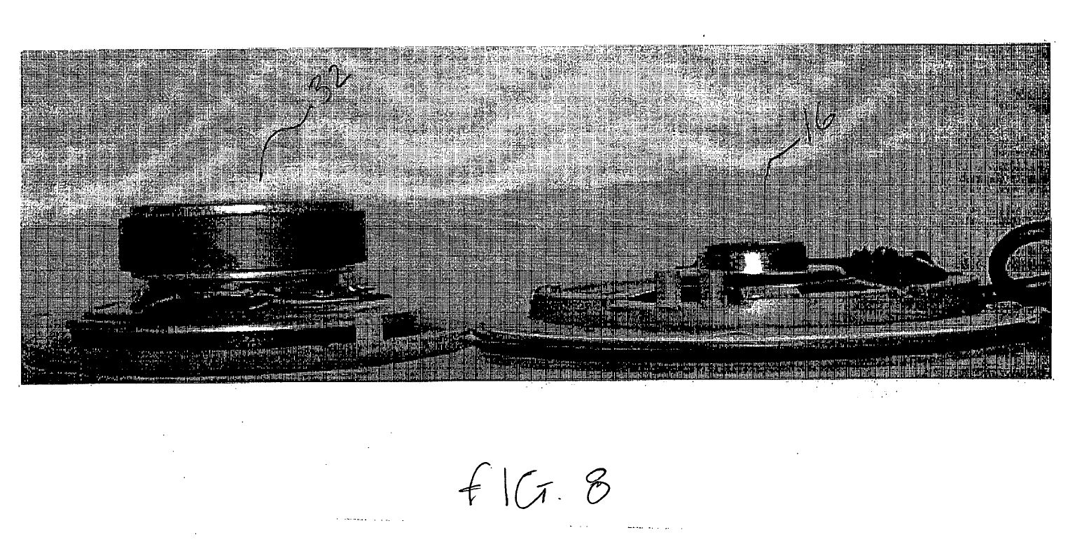

In a preferred embodiment, the speaker housing 16 is constructed so as to not interfere with the contents, such as the commercial items, of the case that it is attached to. For example, the speaker housing 16 is constructed in a manner that does not interfere, or break, one or more of the bottles housed therein during transport. In this regard, and referring now to FIG. 8, the speaker housing 16 is constructed to be thinner than a conventional speaker housing 32. For example, the speaker housing 16 may have thickness of about 10 mm, which is half of its original size. By reducing speaker housing and speaker thickness, the contents of the case do not interfere with the speaker or the speaker housing. As such, this reduces the risk of for example, a speaker magnet striking items such as bottles housed within the case during transport. In other embodiments, the speaker may be less than or greater than about 10 mm, without departing from the scope of the present invention. It is to be understood that the speaker housing and/or the speaker are constructed in a fashion that does not interfere with the contents of the case. As such, the thickness and other dimensions of each of the speaker and the speaker housing may vary depending on the contents.

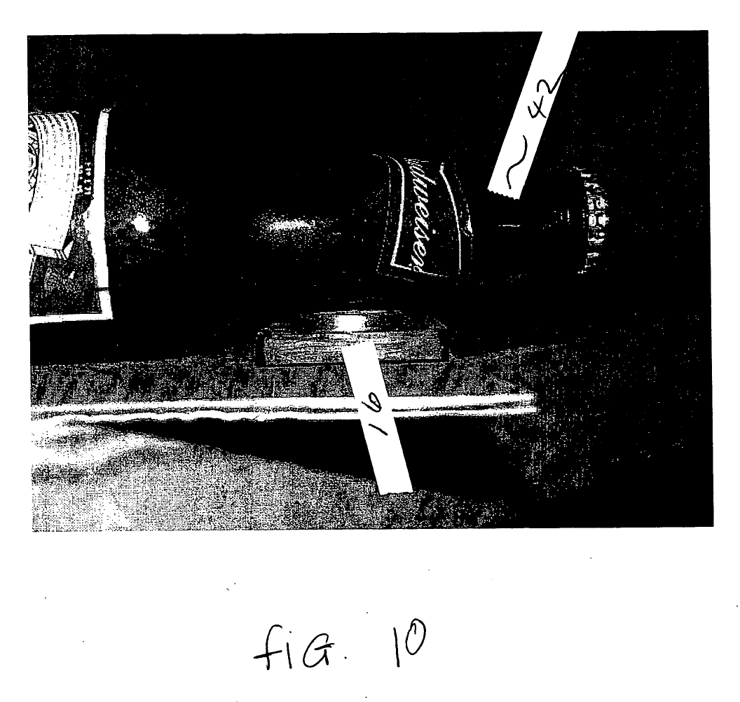

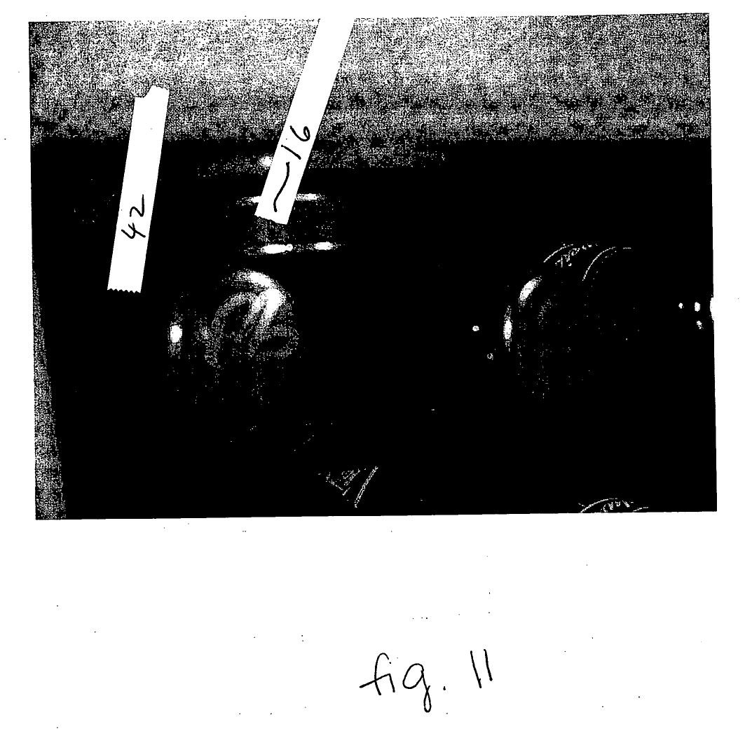

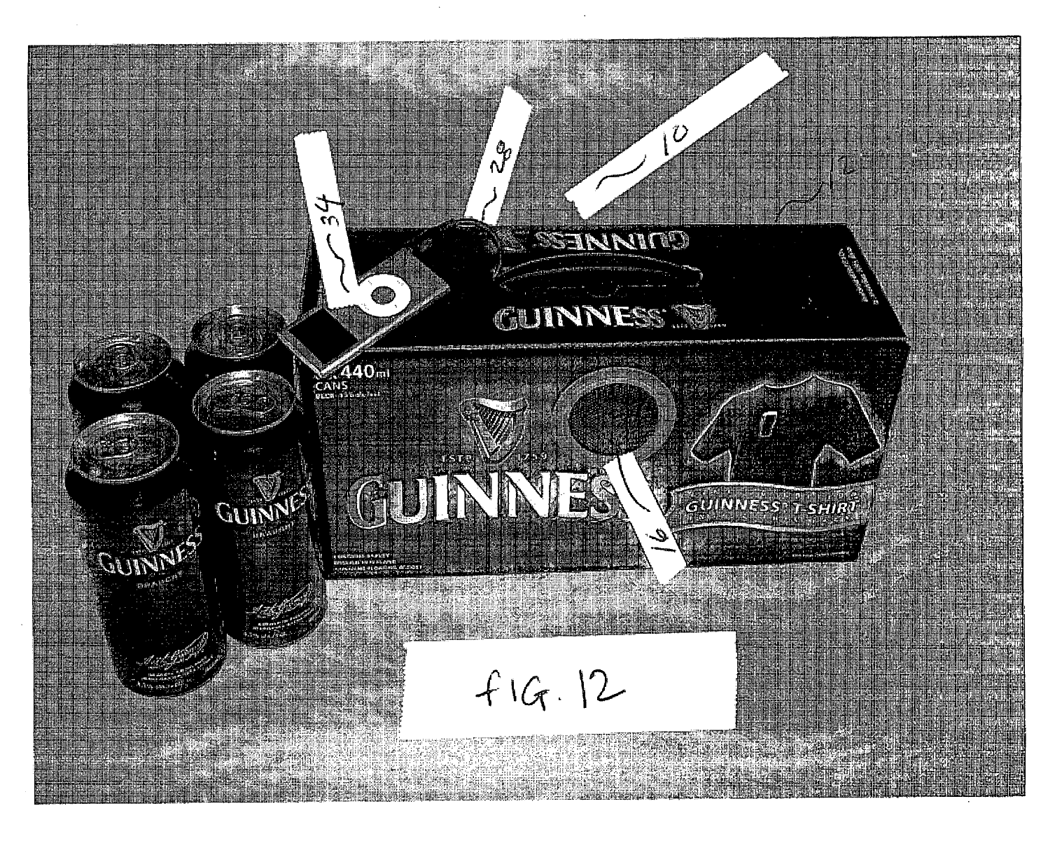

In a preferred embodiment, the speaker housing 16 is placed in an area of the wall 18 that does not interfere with the arrangement of items with the cavity. For example, as seen in FIG. 1, the speaker housing 16 is placed on a top corner of the wall, away from the contents of the cavity. Placement of the speaker housing 16 may also depend on the contents of the cavity. For example, and as best seen in FIGS. 10 and 11, if beer bottles are arranged in the cavity, the speaker housing 16 may be placed on a top portion of the wall adjacent the neck of a beer bottle 42 housed in the cavity, as beer bottle necks are generally smaller in diameter than the lower portions of the beer bottle. As such, the portion of the speaker housing 16 that extends into the cavity is adjacent the neck of the beer bottle 42. In addition, if cans, such as beer cans are arranged in the cavity, the speaker housing 16 may be placed on a middle portion 56 of the wall 18 between paper dividers 54, as best seen in FIG. 13. For example, as seen in FIGS. 12 and 13, two sets of beer cans may be separated by paper dividers 54. A speaker housing 16 may disposed on the middle portion 56 of the wall 18 in a space enclosed by the paper dividers 54, as seen in FIGS. 12 and 13. In other embodiments, the paper dividers may be replaced by any other suitable material.

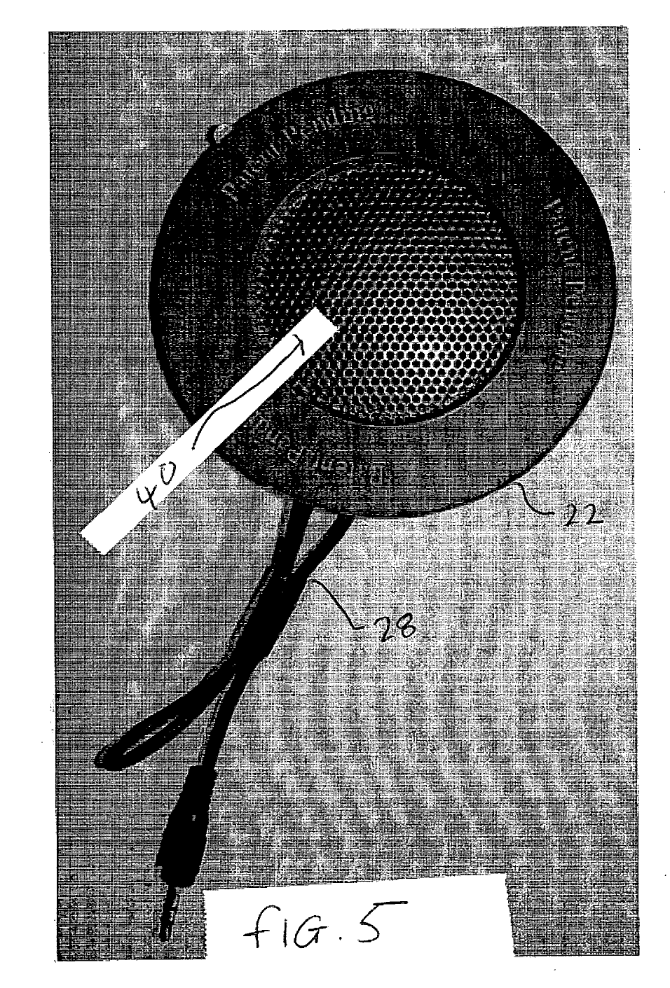

In a preferred embodiment, and referring to FIG. 5, the speaker housing 16 comprises a cover plate 40. Preferably, the cover plate 40 is engaged or attached to the front frame 22. In this way, the cover plate 40 may extend to the outside (as best seen in FIG. 1). The cover plate 40 may be provided for aesthetic purposes as well as for ease of stacking of the cases. Preferably, the cover plate 40 is a metal grill cover plate. In other embodiments, the cover plate 40 may be comprised of other suitable materials and may have other dimensions, depending on the dimensions, for example, of the front plate 22. In yet other embodiments, the cover plate 40 is eliminated.

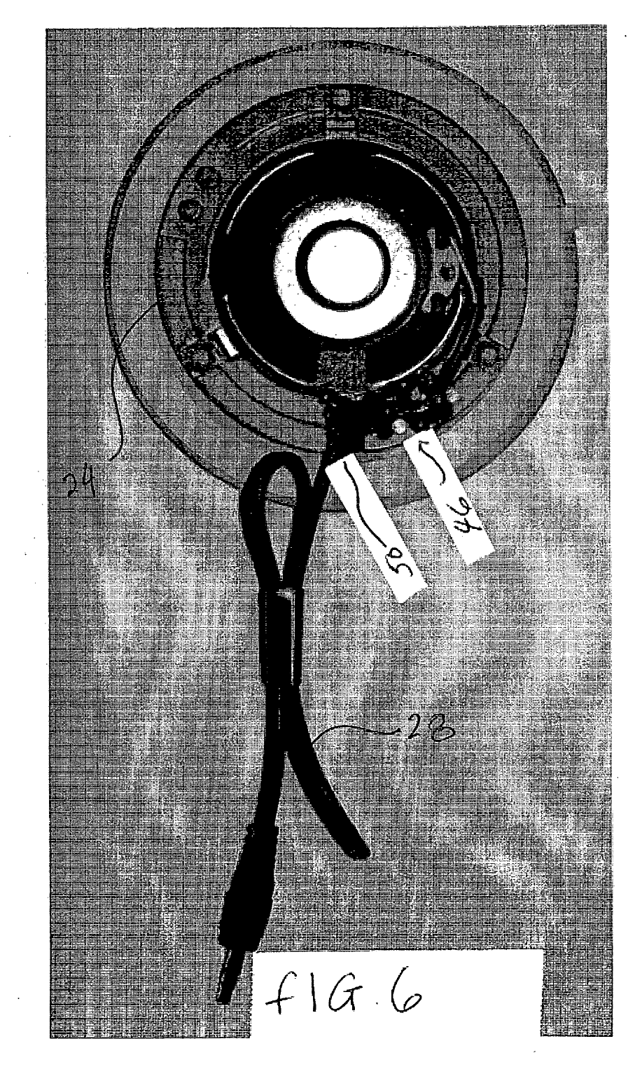

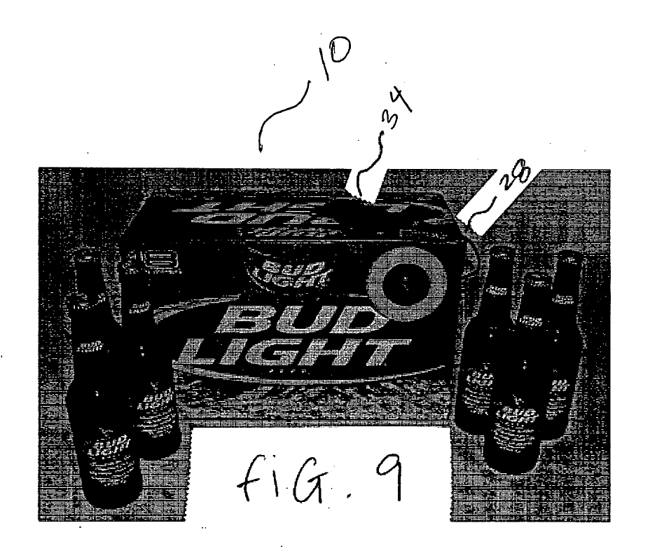

In a preferred embodiment, and referring to FIGS. 5-9, one or more audio cables are provided (referred to singularly and plurally as “28”). The audio cable 28 is preferably housed with the cavity of the structure itself. As best seen in FIG. 6, it is preferably secured in place by the speaker housing 16. For example, the audio cable 28 may be wound around the front or back frame for compact packaging. A portion of the audio cable 28 may be bagged for ease of transport and to ensure that it does not interfere with the contents of the package. Preferably, an end 50 of the audio cable 28 is soldered and/or glued 46 to the speaker housing 16 for extra strength as shown in FIG. 6. The audio cable 28 is preferably about 3 mm in diameter and about 30 cm in length. In a preferred embodiment and as best seen in FIGS. 9 and 12, the audio cable 28 is connected to a MP3 player 34. In other embodiments, the one or more audio cables provided may be any length or diameter.

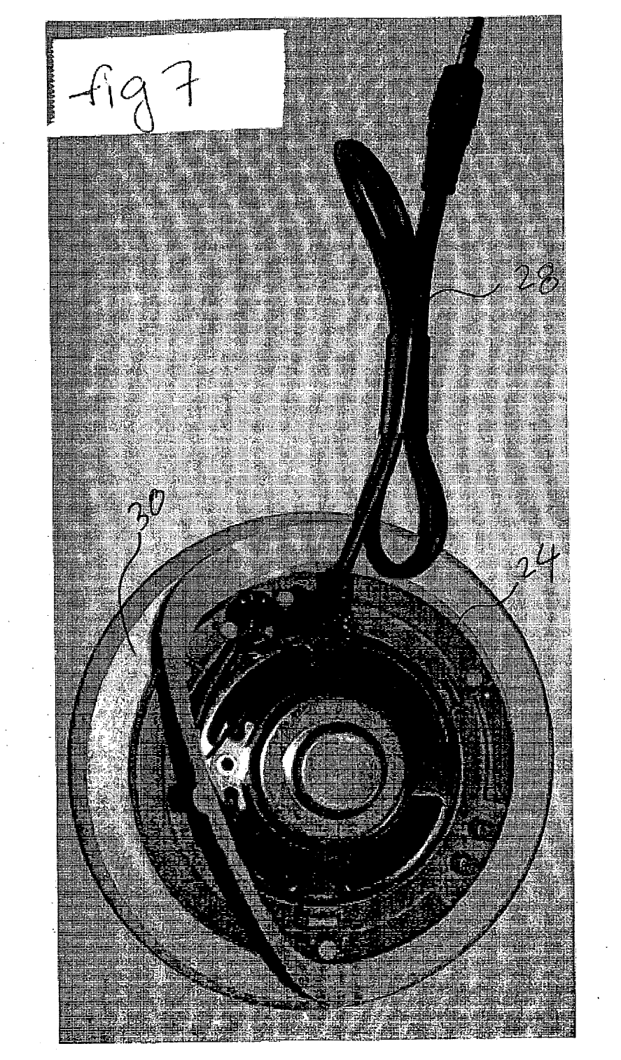

In a preferred embodiment, and as best seen in FIG. 7, the speaker housing 16 is attached to the case 12 via an adhesive tape 30. Preferably, an about 1.5 mm die struck foam adhesive is disposed on the front plate 22 to secure it to the case 12. Use of the struck foam adhesive preferably allows for 100% surface-to-surface adhesion even if the carton is not 100% flat. In other embodiments, the speaker housing 16 may be attached to the case via fasteners, and the like. For example, during manufacture, a hole may be made in a location where the speaker housing 16 is to be placed, and the speaker housing 16 may be attached to the case 12 via the adhesive tape and/or other fastener.

In a preferred embodiment, the placement of the speaker housing allows for increased amplification of the sound generated by the speaker. Specifically, the attachment of the speaker housing to a wall of the structure, as well as its extension from inside the cavity to the outside of the structure, allows for this superior amplification. For example, music from the MP3 player is amplified to a much more greater extent if it is used in the present invention than if it were attached to a speaker housing that was not connected to a case as disclosed herein.

In a preferred embodiment, the methods of the present invention include providing a case having speaker attached thereto as disclosed herein. Preferably, the case comprises a plurality of loose identical items, such as beverage bottles or cans. When on a picnic, at the pool, or tailgating at a football game, for example, the methods of the invention include consuming the contents of the case, such as beer, while listening to music from the case itself. For example, after the case is opened, the audio cables therein may be attached to the MP3 player. In this way, a separate speaker system does not need to be carried to the place of the festivities. This avoids the hassle of carrying multiple items, and allows for enjoyment of the beer or other beverage of choice, as well as music, all in one location. The audio cables provided may be attached to a radio, a receiver, and/or a MP3 player, or the like, for musical enjoyment from many sources.

In a preferred embodiment, the methods of the invention include promoting a commercial item housed in a package. A speaker housing comprising a speaker is attached to the package, and the commercial item is placed in an ordered fashion within the package. By attaching the speaker housing to the package, the commercial interest of the contents thereof is increased. Preferably, consumers are more likely to purchase the commercial items because of the speaker housing having the speaker attached to the package. Preferably, the speaker housing does not interfere with the commercial items in the package. As such, the commercial items can be enjoyed without interference from the speaker housing having the speaker. In a preferred embodiment, the commercial item is beer. However, in other embodiments, other commercial items to be promoted and/or marketed may be placed within the package. These items may or may not be for sale, and may be used for promotional purposes only.

While certain embodiments of the invention have been described, these embodiments have been presented by way of example only, and are not intended to limit the scope of the inventions. Indeed, the novel methods and elements described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A case for a holding a plurality of loose identical items arranged in an ordered fashion, the case comprising
(a) a structure having a cavity, the structure having thin walls and being lightweight;
(b) a plurality of the items to be disposed in the cavity; and
(c) a flat speaker housing comprising a speaker frame and a speaker, the speaker frame supporting the speaker, the speaker housing being attached to a wall of the structure and extending from outside the wall into the cavity, wherein the speaker housing is disposed at an area of the wall that does not interfere with the arrangement of the items in the cavity.

2. The case of claim 1, wherein the items to be disposed in the cavity are cans or bottles.

3. The case of claim 2, wherein the items to be disposed in the cavity are beer cans or bottles.

4. The case of claim 1, wherein the speaker frame comprises flat front and back frames.

5. The case of claim 4, wherein a cover plate attached to the front frame extends from outside the wall into the cavity.

6. The case of claim 1, wherein each of the plurality of items is divided by paper dividers.

7. The case of claim 1, wherein the placement of the speaker housing allows for superior amplification of the sound generated by the speaker.

8. A method for promoting a commercial item, the method comprising:
a. providing a package for housing a plurality of loose identical items in an ordered fashion;
b. attaching a speaker housing to the package;
c. placing a plurality of loose identical items in an ordered fashion in the package,
whereby the speaker housing does not interfere with the placement of the items in the package.

9. The method of claim 8, wherein the speaker housing is flat and comprises a speaker.

10. The method of claim of claim 8, wherein the loose identical items are bottles are cans.

11. The method of claim 10, wherein the loose identical items are beer cans or bottles.

12. The method of claim 8, further comprising providing audio cables that are secured by the speaker housing.
